(19) United States
(12) Patent Application Publication
(10) Pub. No.: US 2025/0141475 A1
(43) Pub. Date: May 1, 2025

(54) RADIO FREQUENCY CONTROL METHOD AND APPARATUS, AND ELECTRONIC DEVICE

(71) Applicant: VIVO MOBILE COMMUNICATION CO., LTD., Dongguan (CN)

(72) Inventors: Jun LI, Dongguan (CN); Wei YI, Dongguan (CN)

(73) Assignee: VIVO MOBILE COMMUNICATION CO., LTD., Dongguan (CN)

(21) Appl. No.: 19/000,836

(22) Filed: Dec. 24, 2024

Related U.S. Application Data
(63) Continuation of application No. PCT/CN2023/101722, filed on Jun. 21, 2023.

(30) Foreign Application Priority Data
Jun. 28, 2022 (CN) 202210762826.6

(51) Int. Cl. H04B 1/00; H04B 1/04

(52) U.S. Cl. CPC H04B 1/0078; H04B 1/0458; H04B 1/0475; H04B 1/0483

(57) ABSTRACT

This application provides a radio frequency control method and apparatus, and an electronic device. The electronic device includes a first power amplifier, a dual-cell battery module, and a voltage conversion chip. The dual-cell battery module is connected to the first power amplifier through the voltage conversion chip. The radio frequency control method includes: detecting a network standard according to which the electronic device operates; and when the network standard according to which the electronic device operates is a first network standard, adjusting a switching frequency of the voltage conversion chip to improve an isolation of the first power amplifier.

### CROSS-REFERENCE TO RELATED APPLICATIONS

This application is a continuation of International Application No. PCT/CN 2023/101722, filed on Jun. 21, 2023, which claims priority to Chinese Patent Application No. 202210762826.6, filed on Jun. 28, 2022. The entire contents of each of the above-referenced applications are expressly incorporated herein by reference.

### TECHNICAL FIELD

This application pertains to the field of communication technologies, and specifically, to a radio frequency control method and apparatus, and an electronic device.

### BACKGROUND

Currently, in mainstream power supply solutions for radio frequency power amplifiers in mobile phone terminals, for example, in a case that a mobile phone terminal operates in a Global System for Mobile Communications (GSM) network standard, a battery directly supplies an operating voltage to a GSM power amplifier. However, with the improvement of current smartphone charging solutions, high-power charging solutions are gradually becoming popular, and most batteries also adopt dual-cell solutions.

In the related art, in a dual-cell battery solution, the voltage of a dual-cell battery is lowered by a 2:1 voltage conversion chip and then supplied to a GSM power amplifier. However, since the voltage conversion chip uses a charge pump power supply architecture, the voltage conversion chip continuously switches through MOS transistor switches to achieve a 2:1 voltage conversion effect, resulting in significant switching noise signals on power output. Power output in this case is directly supplied to the GSM power amplifier, making it extremely easy for the GSM power amplifier to modulate the switching noise signals onto radio frequency signals, thus leading to poor radio frequency performance indicators such as Output Radio Frequency Spectrum (ORFS) and Conducted Spurious Emission (CSE) of the GSM.

### SUMMARY

Embodiments of this application are intended to provide a radio frequency control method and apparatus, and an electronic device.

According to a first aspect, an embodiment of this application provides a radio frequency control method applied to an electronic device, where the electronic device includes a first power amplifier, a dual-cell battery module, and a voltage conversion chip, the dual-cell battery module being connected to the first power amplifier through the voltage conversion chip; and the method includes:
detecting a network standard in which the electronic device operates; and
in a case that the network standard in which the electronic device operates is a first network standard, adjusting a switching frequency of the voltage conversion chip to improve an isolation of the first power amplifier.

According to a second aspect, an embodiment of this application provides a radio frequency control apparatus applied to an electronic device, where the electronic device includes a first power amplifier, a dual-cell battery module, and a voltage conversion chip, the dual-cell battery module being connected to the first power amplifier through the voltage conversion chip; and the apparatus includes:
a detection module, configured to detect a network standard in which the electronic device operates; and
an adjustment module, configured to: in a case that the network standard in which the electronic device operates is a first network standard, adjust a switching frequency of the voltage conversion chip to improve an isolation of the first power amplifier.

According to a third aspect, an embodiment of this application provides an electronic device, where the electronic device includes a processor and a memory, the memory stores a program or instruction capable of running on the processor, and when the program or instruction is executed by the processor, the steps of the method according to the first aspect are implemented.

According to a fourth aspect, an embodiment of this application provides a readable storage medium, where the readable storage medium stores a program or instruction, and when the program or instruction is executed by a processor, the steps of the method according to the first aspect are implemented.

According to a fifth aspect, an embodiment of this application provides a chip, where the chip includes a processor and a communication interface, the communication interface is coupled to the processor, and the processor is configured to run a program or instruction so as to implement the method according to the first aspect.

According to a sixth aspect, an embodiment of this application provides a computer program product, where the program product is stored in a storage medium, and the program product is executed by at least one processor to implement the method according to the first aspect.

In the embodiments of this application, in a case that it is detected that the electronic device is operating in the first network standard, the switching frequency of the voltage conversion chip when operating is adjusted to improve the isolation of the first power amplifier. That is, when the electronic device operates in the first network standard such as a GSM network standard, the electronic device adjusts the switching frequency of the voltage conversion chip when operating to improve an isolation of a GSM power amplifier. Based on the improved isolation, the probability that switching noise signals of the voltage conversion chip when operating affect radio frequency signals can be reduced, thereby improving the radio frequency performance of the GSM network standard.

### BRIEF DESCRIPTION OF DRAWINGS

FIG. 1 is a flowchart of a radio frequency control method according to an embodiment of this application;

FIG. 2 is a schematic structural diagram of a power supply system according to an embodiment of this application;

FIG. 3 is a schematic structural diagram of a voltage conversion chip according to an embodiment of this application;

FIG. 4 is a flowchart of a radio frequency control method according to another embodiment of this application;

FIG. 5 is a flowchart of a radio frequency control method according to another embodiment of this application;

FIG. 6 is a schematic structural diagram of a radio frequency control apparatus according to an embodiment of this application;

FIG. 7 is a schematic structural diagram of an electronic device according to an embodiment of this application; and

FIG. 8 is a schematic structural diagram of an electronic device according to another embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that data used in this way are interchangeable in appropriate circumstances such that the embodiments of this application can be implemented in an order other than those illustrated or described herein. In addition, “first” and “second” are typically used to distinguish objects of a same type and do not limit quantities of the objects. For example, there may be one or more first objects. In addition, “and/or” in the specification and claims represents at least one of connected objects, and the character “/” generally indicates that the associated objects have an “or” relationship.

Before a radio frequency control method provided in the embodiments of this application is described, an electronic device to which the radio frequency control method is applied is first described.

Referring to FIG. 2, a radio frequency circuit 1 of the electronic device may include a transceiver 11, Power Management Integrated Circuits (PMIC) 12, a first radio frequency transmission unit 13, a second radio frequency transmission unit 14, a third radio frequency transmission unit 15, a dual-cell battery module 16, a power supply chip 17, and a voltage conversion chip 18. The first radio frequency transmission unit 13 corresponds to a first network standard, where the first network standard may be a GSM network standard, that is, the first radio frequency transmission unit 13 is configured to transmit GSM radio frequency signals. The second radio frequency transmission unit 14 corresponds to one second network standard, where this second network standard may be a 4G network standard, that is, one second radio frequency transmission unit 14 is configured to transmit 4G radio frequency signals. The third radio frequency transmission unit 15 corresponds to another second network standard, where the another second network standard may be a 5G network standard, that is, another second radio frequency transmission unit 14 is configured to transmit 5G radio frequency signals.

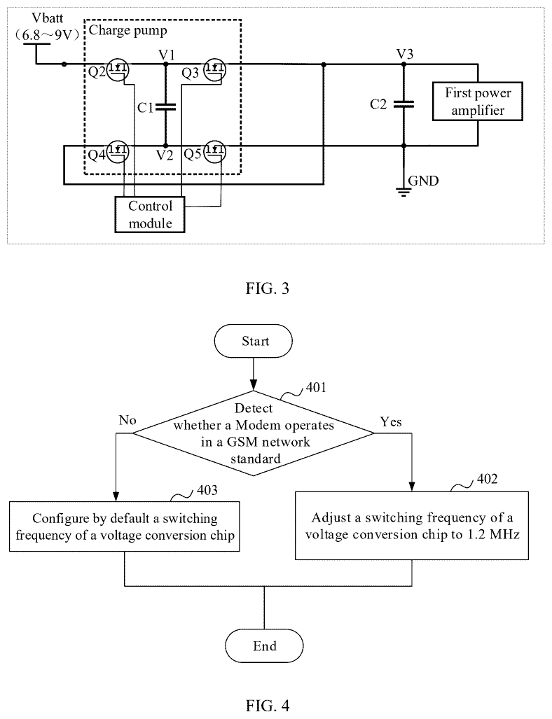

The first radio frequency transmission unit 13 may also be referred to as a cellular transmission module (TXM). As shown in FIG. 3, the first radio frequency transmission unit 13 includes at least a first power amplifier, where the first power amplifier is a GSM power amplifier. An operating voltage of the GSM power amplifier is supplied by the dual-cell battery module 16. An interface voltage Vbatt of the dual-cell battery module 16 ranges from 6.8 V to 9 V. When a dual-cell battery module solution is adopted, as shown in FIG. 2, the interface voltage Vbatt of the dual-cell battery module 16 needs to be subjected to a 2:1 voltage conversion by the voltage conversion chip 18 before supplied to the GSM power amplifier in the first radio frequency transmission unit 13.

However, the voltage conversion chip 18 is a 2:1 voltage conversion chip. As shown in FIG. 3, the voltage conversion chip 18 includes a charge pump module, a control module, and a load capacitor C2. The charge pump module includes a first switch Q2, a second switch Q3, a third switch Q4, a fourth switch Q5, and an external capacitor C1. The first switch Q2, the second switch Q3, the third switch Q4, and the fourth switch Q5 may all be MOS transistor switches. The charge pump module is a core part of the entire voltage conversion chip 18. The conventional operating principle is as follows: In a first step, Q2/Q4 is turned on, Q3/Q5 is turned off, and the external capacitor C1 and the load capacitor C2 divide an input battery voltage Vbatt, and a voltage at a point V2 is 0.5*Vbatt. At this time, a voltage at a point V3 is the same as that at the point V2.

In a second step, Q2/Q4 is turned off, Q3/Q5 is turned on, and the external capacitor C1 and the load capacitor C2 form a loop to discharge. At this time, the voltage at the point V3 is the same as that at the point V1, and the voltage is 0.5*Vbatt. When the first power amplifier consumes different operating currents, the operating frequencies of Q2/Q4 and Q3/Q5 are different. Thus, since switch tubes continuously switch, the effective value of the output voltage V3 is 0.5*Vbatt, but there is significant switching noise. Power output in this case is directly supplied to the GSM power amplifier, leading to poor radio frequency performance indicators such as ORFS and CSE of the GSM.

The following describes in detail the radio frequency control method provided in the embodiments of this application through specific embodiments and application scenarios thereof with reference to the accompanying drawings.

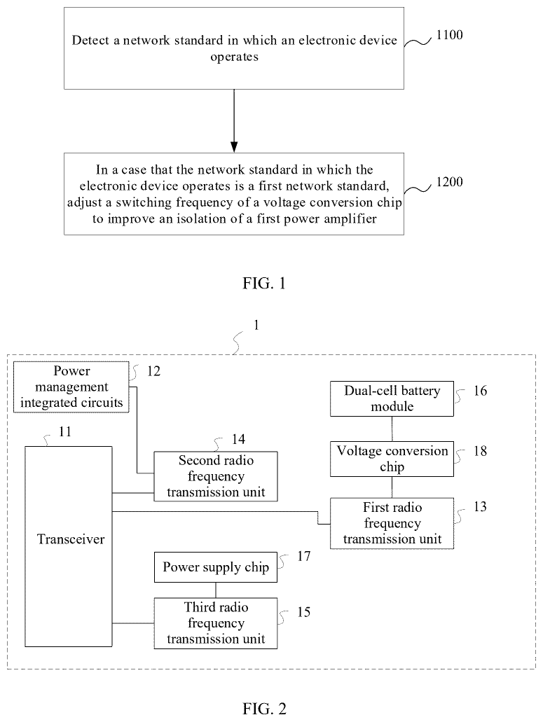

Referring to FIG. 1, FIG. 1 is a flowchart of a radio frequency control method according to an embodiment of this application. The method may be applied to an electronic device, where the electronic device may be a mobile phone, a tablet computer, a notebook computer, or the like. The electronic device includes a first power amplifier, a dual-cell battery module, and a voltage conversion chip, where the dual-cell battery module is connected to the first power amplifier through the voltage conversion chip. The first power amplifier may be a GSM power amplifier, the dual-cell battery module may be the dual-cell battery module 16 shown in FIG. 2, and the voltage conversion chip may be the voltage conversion chip 18 shown in FIG. 2. As shown in FIG. 1, the method may include steps 1100 to 1200, and the steps are described in detail below.

Step 1100: Detect a network standard in which the electronic device operates.

In this embodiment, the network standard in which the electronic device operates may be any network standard such as a GSM network standard, a 5G network standard, or a 4G network standard.

In specific implementation, when the electronic device is in a power-on state, a network standard in which a modem in the electronic device operates can be detected, and the network standard in which the modem operates is determined to be the network standard in which the electronic device operates.

Here, in a case that the network standard in which the electronic device operates is a network standard other than the GSM network standard, that is, the electronic device does not operate in the GSM network standard, the electronic device can configure switching frequencies of switches in the voltage conversion chip according to the default state. The switching frequency generally refers to the number of times the switch can be turned on per second. In some embodiments, the electronic device can configure the switching frequencies of the switches in the voltage conversion chip to be 200 KHz to 1.0 MHz. For example, the electronic device can configure by default the switching frequencies of the switches in the voltage conversion chip to be 250 KHz.

Conversely, in a case that the electronic device operates in the GSM network standard, the dual-cell battery module can supply the voltage required for the GSM power amplifier to operate through the voltage conversion chip. Since the voltage conversion chip operates at 200 KHz to 1.0 MHz by default, an isolation of the GSM power amplifier is low, making it extremely easy to modulate switching noise onto radio frequency signals, thus leading to poor radio frequency performance indicators of the GSM. Here, the switching frequency of the voltage conversion chip needs to be adjusted to a first switching frequency to improve an isolation of a first power amplifier, that is, the GSM power amplifier. For how to adjust the switching frequency of the voltage conversion chip to the first switching frequency to improve the isolation of the first power amplifier, that is, the GSM power amplifier, reference may be made to the following embodiments.

Step 1200: In a case that the network standard in which the electronic device operates is a first network standard, adjust the switching frequency of the voltage conversion chip to improve the isolation of the first power amplifier.

The first network standard may be the GSM network standard. Correspondingly, the first power amplifier is the GSM power amplifier.

In this embodiment, different switching frequencies of the voltage conversion chip result in different isolations of the GSM power amplifier. The isolation is used to measure the capability of the first power amplifier in suppressing noise signals. A higher isolation leads to higher capability of the first power amplifier in suppressing noise signals, and the isolation is measured in dB. In this embodiment, the first power amplifier includes a power network and a radio frequency network. The step of improving the isolation of the first power amplifier may further include: improving an isolation between the power network and the radio frequency network, thereby avoiding the modulation of power switching noise onto radio frequency signals, which otherwise affects the radio frequency performance indicators.

In an embodiment, the step 1200 of, in a case that the network standard in which the electronic device operates is a first network standard, adjusting the switching frequency of the voltage conversion chip to improve the isolation of the first power amplifier may further include: in the case that the network standard in which the electronic device operates is the first network standard, adjusting the switching frequency of the voltage conversion chip to a first switching frequency to improve the isolation of the first power amplifier.

It can be understood that in a case that the electronic device operates in the GSM network standard and the switching frequency of the voltage conversion chip is 200 KHz to 1.0 MHz, for example, the switching frequency of the voltage conversion chip is 250 MHz by default, the dual-cell battery module supplies the voltage required for the GSM power amplifier to operate through the voltage conversion chip. Since switching noise signals are present due to the continuous switching of the voltage conversion chip when operating, and the switching frequency of the voltage conversion chip is 200 KHz to 1.0 MHz, the isolation of the GSM power amplifier is very low, making it extremely easy for the GSM power amplifier to modulate switching noise signals onto radio frequency signals, thus leading to poor radio frequency performance indicators such as ORFS and CSE of the GSM.

The first network standard is the GSM network standard. The first switching frequency may be 1.2 MHz and the first switching frequency is obtained based on experimental data test. For example, in a case that the switching frequency of the voltage conversion chip is 200 KHz to 1.0 MHz, the isolation of the GSM power amplifier is a first value, and in a case that the switching frequency of the voltage conversion chip is 1.2 MHZ, the isolation of the GSM power amplifier is a second value. The second value is greater than the first value, and in the case that the switching frequencies of the switches in the voltage conversion chip are 1.2 MHZ, the isolation of the GSM power amplifier is the highest, making the radio frequency performance of the GSM power amplifier the best. Furthermore, in a scenario in which the switching frequencies of the switches are 1.2 MHz, an actually measured current is about 4 mA higher than that in a scenario in which the switching frequencies of the switches are 250 KHz. Since the maximum current in a transmission slot of the GSM network standard reaches more than 1.8 A, the increase of only about 4 mA of current in the transmission slot leads to a controllable range of power consumption in user scenarios.

In specific implementation, in a case that the electronic device operates in the GSM network standard, the switching frequencies of the switches in the voltage conversion chip are adjusted to 1.2 MHz. Since the isolation of the GSM power amplifier is the highest in a case that the switching frequency is 1.2 MHZ, the switching noise signals can be suppressed to a greater extent, thereby avoiding the modulation of the switching noise signals onto the radio frequency signals, improving the radio frequency performance indicators such as ORFS and CSE of the GSM, and ensuring the radio frequency performance of the GSM.

According to this embodiment, in the case that the electronic device operates in the GSM network standard, the switching frequency of the voltage conversion chip is adjusted to 1.2 MHz. In a case that the switching frequency of the voltage conversion chip is 1.2 MHZ, the isolation of the GSM power amplifier is the highest, so that the switching noise signals can be suppressed to the greatest extent, thereby avoiding the modulation of the switching noise signals onto the radio frequency signals, improving the radio frequency performance indicators such as ORFS and CSE of the GSM, and ensuring the radio frequency performance of the GSM.

In an embodiment, the step 1200 of, in the case that the network standard in which the electronic device operates is the first network standard, adjusting the switching frequency of the voltage conversion chip to a first switching frequency to improve the isolation of the first power amplifier may further include: in the case that the network standard in which the electronic device operates is the first network standard, determining an operating mode of the first network standard; and in a case that the operating mode of the first network standard is a time division duplex mode, adjusting the switching frequency of the voltage conversion chip to the first switching frequency in a first time period to improve the isolation of the first power amplifier.

The first time period is a slot in which radio frequency signals are transmitted through the first network standard. It can be understood that in the foregoing embodiment, the switching frequency of the voltage conversion chip needs to be adjusted in both a transmission slot and a reception slot of the GSM, leading to reduced conversion efficiency of the voltage conversion chip and increased power consumption. In this embodiment, the switching frequency of the voltage conversion chip is adjusted in only the slot in which the radio frequency signals are transmitted through the GSM network standard, achieving lower power consumption.

In specific implementation, in a case that the electronic device operates in the GSM network standard, the switching frequency of the voltage conversion chip is adjusted to 1.2 MHz only in the transmission slot of the GSM network standard. Since the isolation of the GSM power amplifier is the highest in a case that the switching frequency is 1.2 MHZ, the switching noise signals can be suppressed to a greater extent, thereby avoiding the modulation of the switching noise signals onto the radio frequency signals, improving the radio frequency performance indicators such as ORFS and CSE of the GSM, and ensuring the radio frequency performance of the GSM. In the receiving slot of the GSM network standard, the switching frequencies of the switches in the voltage conversion chip can be configured to be 200 KHz to 1.0 MHz. For example, the switching frequencies of the switches in the voltage conversion chip are configured to be 250 KHz by default.

According to this embodiment, in the case that the electronic device operates in the GSM network standard, the switching frequencies of the switches in the voltage conversion chip are adjusted to 1.2 MHz only in the transmission slot of the GSM network standard. The power consumption is only ⅛ of that in the foregoing embodiment (the transmission slot of the GSM network standard is ⅛ slot), that is, ⅛*4-0.5 mA. Thus the increase in power consumption can be ignored.

In the embodiments of this application, in a case that it is detected that the electronic device is operating in the first network standard, the switching frequency of the voltage conversion chip when operating is adjusted to improve the isolation of the first power amplifier. That is, when the electronic device operates in the first network standard such as a GSM network standard, the electronic device adjusts the switching frequency of the voltage conversion chip when operating to improve an isolation of a GSM power amplifier. Based on the improved isolation, the probability that switching noise signals of the voltage conversion chip when operating affect radio frequency signals can be reduced, thereby improving the radio frequency performance of the GSM network standard.

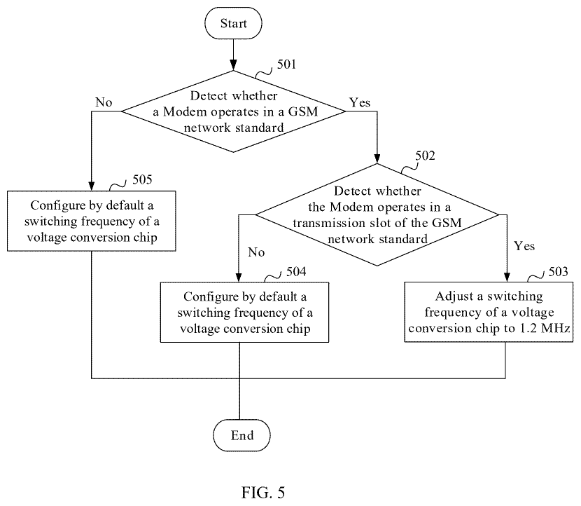

Next, a radio frequency control method according to an embodiment is described. Referring to FIG. 4, the radio frequency control method may include the following steps:

Step 401: Detect a network standard in which a modem operates; in a case that the network standard in which the modem operates being a GSM network standard has been detected, perform step 402; otherwise, perform step 403.

Step 402: In the case that the network standard in which the modem operates being the GSM network standard has been detected, adjust and lock a switching frequency of a voltage conversion chip to 1.2 MHZ, and end the process.

Step 403: In a case that the network standard in which the modem operates being not the GSM network standard has been detected, configure by default the switching frequency of the voltage conversion chip to 250 KHz, and end the process.

Next, a radio frequency control method according to an embodiment is described. Referring to FIG. 5, the radio frequency control method may include the following steps:

Step 501: Detect a network standard in which a modem operates; in a case that the network standard in which the modem operates being a GSM network standard has been detected, perform step 502; otherwise, perform step 505.

Step 502: In the case that the network standard in which the modem operates being the GSM network standard has been detected, further detect whether the modem operates in a transmission slot of the GSM network standard; if yes, perform step 503; otherwise, perform step 504.

Step 503: In a case that the modem operating in the transmission slot of the GSM network standard has been detected, adjust and lock a switching frequency of a voltage conversion chip to 1.2 MHz, and end the process.

Step 504: In a case that the modem operating in a reception slot of the GSM network standard has been detected, configure by default the switching frequency of the voltage conversion chip to 250 KHz, and end the process.

Step 505: In a case that the network standard in which the modem operates being not the GSM network standard has been detected, configure by default the switching frequency of the voltage conversion chip to 250 KHz, and end the process.

It should be noted that the radio frequency control method provided in the embodiments of this application may be applied to other scenarios, such as operating scenarios of an audio power amplifier.

It should be noted that a radio frequency control apparatus provided in the embodiments of this application can implement the processes implemented in the method embodiment in FIG. 1. To avoid repetition, details are not described herein again.

It should be noted that the radio frequency control method provided in the embodiments of this application can be executed by the radio frequency control apparatus. In the embodiments of this application, the radio frequency control method being executed by the radio frequency control apparatus is used as an example to describe the radio frequency control apparatus provided in the embodiments of this application.

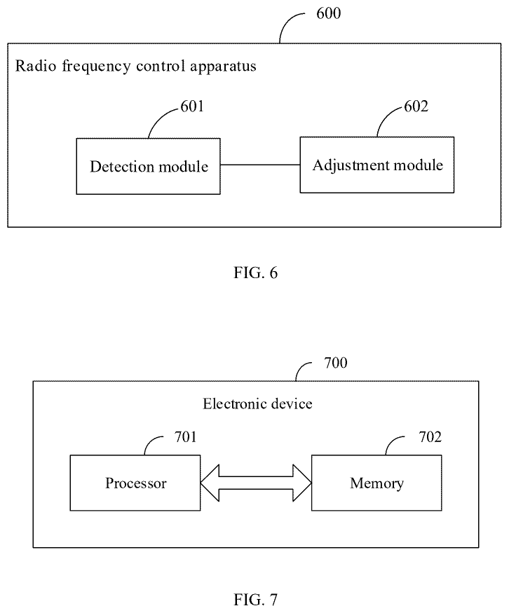

Corresponding to the foregoing embodiments, referring to FIG. 6, an embodiment of this application further provides a radio frequency control apparatus 600 applied to an electronic device. The electronic device includes a first power amplifier, a dual-cell battery module, and a voltage conversion chip, where the dual-cell battery module is connected to the first power amplifier through the voltage conversion chip. The apparatus 600 includes a detection module 601 and an adjustment module 602.

The detection module 601 is configured to detect a network standard in which the electronic device operates.

The adjustment module 602 is configured to: in a case that the network standard in which the electronic device operates is a first network standard, adjust a switching frequency of the voltage conversion chip to improve an isolation of the first power amplifier.

In an embodiment, the adjustment module 602 is configured to: in the case that the network standard in which the electronic device operates is the first network standard, adjust the switching frequency of the voltage conversion chip to a first switching frequency to improve the isolation of the first power amplifier.

In an embodiment, the adjustment module 602 is configured to: in the case that the network standard in which the electronic device operates is the first network standard, determine an operating mode of the first network standard; and in a case that the operating mode of the first network standard is a time division duplex mode, adjust the switching frequency of the voltage conversion chip to the first switching frequency in a first time period to improve the isolation of the first power amplifier, where the first time period is a slot in which radio frequency signals are transmitted through the first network standard.

In an embodiment, the first network standard is a GSM network standard, and the first switching frequency is 1.2 MHz.

In an embodiment, the adjustment module 602 is configured improve an isolation between the power network and the radio frequency network.

In the embodiments of this application, in a case that it is detected that the electronic device is operating in the first network standard, the switching frequency of the voltage conversion chip when operating is adjusted to improve the isolation of the first power amplifier. That is, when the electronic device operates in the first network standard such as a GSM network standard, the electronic device adjusts the switching frequency of the voltage conversion chip when operating to improve an isolation of a GSM power amplifier. Based on the improved isolation, the probability that switching noise signals of the voltage conversion chip when operating affect radio frequency signals can be reduced, thereby improving the radio frequency performance of the GSM network standard.

The radio frequency control apparatus in the embodiments of this application may be an electronic device or a component in an electronic device such as an integrated circuit or chip. The electronic device may be a terminal or other devices than terminals. For example, the electronic device may be a mobile phone, a tablet computer, a notebook computer, a palmtop computer, a vehicular electronic device, a Mobile Internet Device (MID), an Augmented Reality (AR)/Virtual Reality (VR) device, a robot, a wearable device, an Ultra-Mobile Personal Computer (UMPC), a netbook, a Personal Digital Assistant (PDA), or the like. In some embodiments, the electronic device may be a server, a Network Attached Storage (NAS), a Personal Computer (PC), a television (TV), a teller machine, a self-service machine, or the like. This is not specifically limited in this embodiment of this application.

The radio frequency control apparatus in this embodiment of this application may be an apparatus having an operating system. The operating system may be an Android operating system, an iOS operating system, or other possible operating systems, and is not specifically limited in this embodiment of this application.

The radio frequency control apparatus provided in this embodiment of this application can implement the processes implemented in the method embodiment in FIG. 1. To avoid repetition, details are not described herein again.

For example, as shown in FIG. 7, an embodiment of this application further provides an electronic device 700 including a processor 701 and a memory 702, where the memory 702 stores a program or instruction capable of running on the processor 701, and when the program or instruction is executed by the processor 701, the steps of the foregoing radio frequency control method embodiments are implemented, with the same technical effects achieved. To avoid repetition, details are not described herein again.

It should be noted that the electronic device in this embodiment of this application includes the foregoing mobile electronic device and a non-mobile electronic device.

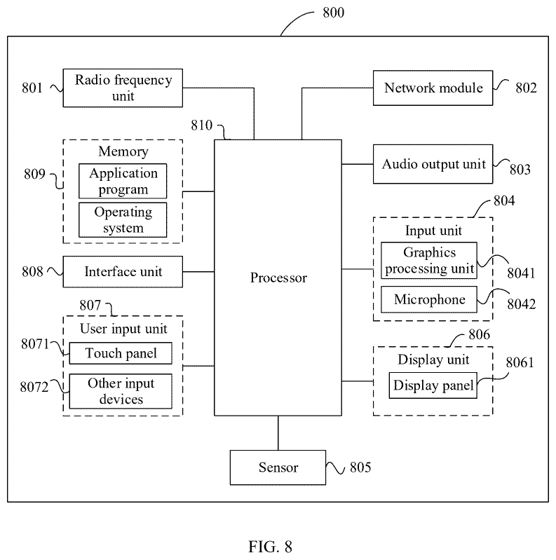

FIG. 8 is a schematic diagram of a hardware structure of an electronic device according to an embodiment of this application.

The electronic device 800 includes but is not limited to components such as a radio frequency unit 801, a network module 802, an audio output unit 803, an input unit 804, a sensor 805, a display unit 806, a user input unit 807, an interface unit 808, a memory 809, and a processor 810.

Persons skilled in the art can understand that the electronic device 800 may further include a power supply (for example, a battery) that supplies power to various components. The power supply may be logically connected to the processor 810 through a power management system, so that functions such as charge and discharge management and power consumption management are implemented via the power management system. The structure of the electronic device shown in FIG. 8 does not constitute a limitation on the electronic device. The electronic device may include more or fewer components than shown in the figure, or some components may be combined, or there may be a different component layout. Details are not described herein again.

The processor 810 is configured to: detect a network standard in which the electronic device operates; and in a case that the network standard in which the electronic device operates is a first network standard, adjust a switching frequency of the voltage conversion chip to improve an isolation of the first power amplifier.

According to this embodiment, in a case that it is detected that the electronic device is operating in the first network standard, the switching frequency of the voltage conversion chip when operating is adjusted to improve the isolation of the first power amplifier. That is, when the electronic device operates in the first network standard such as a GSM network standard, the electronic device adjusts the switching frequency of the voltage conversion chip when operating to improve an isolation of a GSM power amplifier. Based on the improved isolation, the probability that switching noise signals of the voltage conversion chip when operating affect radio frequency signals can be reduced, thereby improving the radio frequency performance of the GSM network standard.

In an embodiment, the processor 810 is further configured to: in the case that the network standard in which the electronic device operates is the first network standard, adjust the switching frequency of the voltage conversion chip to a first switching frequency to improve the isolation of the first power amplifier.

In an embodiment, the processor 810 is further configured to: in the case that the network standard in which the electronic device operates is the first network standard, determine an operating mode of the first network standard; and in a case that the operating mode of the first network standard is a time division duplex mode, adjust the switching frequency of the voltage conversion chip to the first switching frequency in a first time period to improve the isolation of the first power amplifier, where the first time period is a slot in which radio frequency signals are transmitted through the first network standard.

In an embodiment, the first network standard is a GSM network standard, and the first switching frequency is 1.2 MHz.

In an embodiment, the processor 810 is further configured improve an isolation between the power network and the radio frequency network.

It can be understood that in this embodiment of this application, the input unit 804 may include a Graphics Processing Unit (GPU) 8041 and a microphone 8042. The graphics processing unit 8041 processes image data of a still picture or video obtained by an image capture apparatus (such as a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and other input devices 8072. The touch panel 8071 is also referred to as a touchscreen. The touch panel 8071 may include two parts: a touch detection apparatus and a touch controller. The other input devices 8072 may include but are not limited to a physical keyboard, a function button (for example, volume control button or on/off button), a trackball, a mouse, and a joystick. Details are not described herein.

The memory 809 may be configured to store software programs and various data. The memory 809 may include a first storage area for storing a program or instruction and a second storage area for storing data. The first storage area may store an operating system, an application program or instruction required by at least one function (for example, a sound play function or an image play function), and the like. In addition, the memory 809 may include a volatile memory or a non-volatile memory, or the memory 809 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 809 in this embodiment of this application includes but is not be limited to these or any other applicable types of memories. The memory 809 may include a program storage area and a data storage area. The program storage area may store an operating system, an application program required for at least one function (such as a sound play function and an image play function), and the like. The data storage area may store data created based on use of the mobile terminal (such as audio data and a phone book), and the like. In addition, the memory 809 may include a high-speed random access memory, and may further include a non-volatile memory such as at least one disk storage device, a flash memory device, or another volatile solid-state storage device.

The processor 810 runs or executes software programs and/or modules stored in the memory 809 and invokes data stored in the memory 809. The processor 810 may include one or more processing units. For example, the processor 810 may integrate an application processor and a modem processor. The application processor primarily processes operations involving an operating system, user interface, application program, and the like. The modem processor primarily processes radio communication signals, for example, being a baseband processor. It can be understood that the modem processor may be not integrated in the processor 810.

An embodiment of this application further provides a readable storage medium, where the readable storage medium stores a program or instruction, and when the program or instruction is executed by a processor, the processes of the foregoing radio frequency control method embodiments are implemented, with the same technical effects achieved. To avoid repetition, details are not described again herein.

The processor is a processor in the electronic device described in the foregoing embodiments. The readable storage medium includes a computer-readable storage medium such as a computer read-only memory ROM, a random access memory RAM, a magnetic disk, or an optical disc.

An embodiment of this application further provides a chip, where the chip includes a processor and a communication interface, the communication interface is coupled to the processor, and the processor is configured to run a program or instruction to implement the processes of the foregoing radio frequency control method embodiments, with the same technical effects achieved. To avoid repetition, details are not described herein again.

It should be understood that the chip mentioned in this embodiment of this application may also be referred to as a system-level chip, a system chip, a chip system, a system-on-chip, or the like.

An embodiment of this application further provides a computer program product, where the program product is stored in a storage medium, and the program product is executed by at least one processor to implement the processes of the foregoing radio frequency control method embodiments, with the same technical effects achieved. To avoid repetition, details are not described herein again.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples may be combined in other examples.

Based on the foregoing description of embodiments, persons skilled in the art can clearly understand that the method in the foregoing embodiments can be implemented through software on a necessary hardware platform or through hardware only, but in many cases, the former is the example implementation. Based on such an understanding, the technical solutions of this application essentially or the part contributing to the prior art may be implemented in a form of a software product. The software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A radio frequency control method executed by an electronic device, wherein the electronic device comprises a first power amplifier, a dual-cell battery module, and a voltage conversion chip, the dual-cell battery module being connected to the first power amplifier through the voltage conversion chip; and the radio frequency control method comprises:
detecting a network standard according to which the electronic device operates; and
when the network standard according to which the electronic device operates is a first network standard, adjusting a switching frequency of the voltage conversion chip to improve an isolation of the first power amplifier.

2. The radio frequency control method according to claim 1, wherein when the network standard according to which the electronic device operates is the first network standard, adjusting the switching frequency of the voltage conversion chip to improve the isolation of the first power amplifier comprises:
when the network standard according to which the electronic device operates is the first network standard, adjusting the switching frequency of the voltage conversion chip to a first switching frequency to improve the isolation of the first power amplifier.

3. The radio frequency control method according to claim 2, wherein when the network standard according to which the electronic device operates is the first network standard, adjusting the switching frequency of the voltage conversion chip to the first switching frequency to improve the isolation of the first power amplifier comprises:
when the network standard according to which the electronic device operates is the first network standard, determining an operating mode of the first network standard; and
when the operating mode of the first network standard is a time division duplex mode, adjusting the switching frequency of the voltage conversion chip to the first switching frequency in a first time period to improve the isolation of the first power amplifier, wherein
the first time period is a slot for transmitting a radio frequency signal through the first network standard.

4. The radio frequency control method according to claim 2 or 3, wherein the first network standard is a GSM network standard, and the first switching frequency is 1.2 MHz.

5. The radio frequency control method according to claim 1, wherein the first power amplifier comprises a power network and a radio frequency network; and the improving the isolation of the first power amplifier comprises:
improving an isolation between the power network and the radio frequency network.

6. An electronic device, comprising a processor and a memory storing instructions, wherein the instructions, when executed by the processor, cause the processor to perform operations comprising:
detecting a network standard according to which the electronic device operates; and
when the network standard according to which the electronic device operates is a first network standard, adjusting a switching frequency of the voltage conversion chip to improve an isolation of the first power amplifier.

7. The electronic device according to claim 6, wherein when the network standard according to which the electronic device operates is the first network standard, adjusting the switching frequency of the voltage conversion chip to improve the isolation of the first power amplifier comprises:
when the network standard according to which the electronic device operates is the first network standard, adjusting the switching frequency of the voltage conversion chip to a first switching frequency to improve the isolation of the first power amplifier.

8. The electronic device according to claim 7, wherein when the network standard according to which the electronic device operates is the first network standard, adjusting the switching frequency of the voltage conversion chip to the first switching frequency to improve the isolation of the first power amplifier comprises:
when the network standard according to which the electronic device operates is the first network standard, determining an operating mode of the first network standard; and
when the operating mode of the first network standard is a time division duplex mode, adjusting the switching frequency of the voltage conversion chip to the first switching frequency in a first time period to improve the isolation of the first power amplifier, wherein
the first time period is a slot for transmitting a radio frequency signal through the first network standard.

9. The electronic device according to claim 7 or 8, wherein the first network standard is a GSM network standard, and the first switching frequency is 1.2 MHz.

10. The electronic device according to claim 6, wherein the first power amplifier comprises a power network and a radio frequency network; and the improving the isolation of the first power amplifier comprises:
improving an isolation between the power network and the radio frequency network.

11. A non-transitory computer readable storage medium storing instructions, that, when executed by a processor of an electronic device, cause the processor to perform operations comprising:
detecting a network standard according to which the electronic device operates; and
when the network standard according to which the electronic device operates is a first network standard, adjusting a switching frequency of the voltage conversion chip to improve an isolation of the first power amplifier.

12. The non-transitory computer readable storage medium according to claim 11, wherein when the network standard according to which the electronic device operates is the first network standard, adjusting the switching frequency of the voltage conversion chip to improve the isolation of the first power amplifier comprises:
when the network standard according to which the electronic device operates is the first network standard, adjusting the switching frequency of the voltage conversion chip to a first switching frequency to improve the isolation of the first power amplifier.

13. The non-transitory computer readable storage medium according to claim 12, wherein when the network standard according to which the electronic device operates is the first network standard, adjusting the switching frequency of the voltage conversion chip to the first switching frequency to improve the isolation of the first power amplifier comprises:
when the network standard according to which the electronic device operates is the first network standard, determining an operating mode of the first network standard; and
when the operating mode of the first network standard is a time division duplex mode, adjusting the switching frequency of the voltage conversion chip to the first switching frequency in a first time period to improve the isolation of the first power amplifier, wherein
the first time period is a slot for transmitting a radio frequency signal through the first network standard.

14. The non-transitory computer readable storage medium according to claim 12 or 13, wherein the first network standard is a GSM network standard, and the first switching frequency is 1.2 MHz.

15. The non-transitory computer readable storage medium according to claim 11, wherein the first power amplifier comprises a power network and a radio frequency network; and the improving the isolation of the first power amplifier comprises:
improving an isolation between the power network and the radio frequency network.
